(19) United States
(12) Patent Application Publication
(10) Pub. No.: US 2019/0352943 A1
(43) Pub. Date: Nov. 21, 2019

(54) HANDLE COMPRISING A MULTI-FUNCTIONAL CONTROL ELEMENT

(71) Applicant: Huf Hülsbeck & Fürst GmbH & Co. KG, Velbert (DE)

(72) Inventors: Willi Put, Winterswijk Meddo (NL); Marion Kilian, Velbert (DE); Oleg Dornhof, Neuss (DE)

(21) Appl. No.: 16/484,128

(22) PCT Filed: Feb. 19, 2018
(86) PCT No.: PCT/EP2018/053979

§ 371 Date: Aug. 7, 2019

(30) Foreign Application Priority Data
Feb. 24, 2017 (DE) 10 2017 103 960.0

(51) Int. Cl. E05B 79/06; E05B 85/06

(52) U.S. Cl. CPC E05B 79/06; E05B 85/16; E05B 85/06

(57) ABSTRACT

A handle for a motor vehicle includes a mounting carrier which can be secured on the inside of a door of the motor vehicle, a grip level that can be arranged on the outside of the door of the motor vehicle and is secured to said mounting carrier, and an activation element which is positioned movable on the mounting carrier. The mounting carrier comprises a control element that can be moved between a retaining position and a securing position. The control element engages with the activation element in the retaining position such that the activation element is retained in a mounting position in order to allow the grip level to be mounted more easily, and the control element is detached from the activation element when in the securing position.

### CROSS REFERENCE TO RELATED APPLICATIONS

This application claims priority under 35 U.S.C. § 371 to Patent Cooperation Treaty Application No. PCT/EP2018/053979, filed Feb. 19, 2018, which claims priority to DE Application No. 102017103960.0, filed Feb. 24, 2017, the contents of which are incorporated herein by reference in their entireties.

### FIELD

The present invention relates to a handle for a vehicle. Furthermore, the invention relates to a method for mounting a handle for a motor vehicle.

### BACKGROUND

This section provides background information related to the present disclosure and is not necessarily prior art.

It is known from the prior art to mount handles of a motor vehicle with a mounting carrier which is fastened on the inside of a motor vehicle door, and a grip lever, which is arranged on the outside of the door. It has been shown disadvantageously that there are always mounting delays and mounting inaccuracies. Among other things, it is because some components of the handle are difficult to mount due to their geometry, especially as the space conditions often complicate this.

It is therefore an object of the present invention to at least partially overcome the disadvantages described above. In particular, it is the object of the present invention to create a handle that can be fastened on the motor vehicle as installation-friendly as possible.

### SUMMARY

This section provides a general summary of the disclosure, and is not a comprehensive disclosure of its full scope or all its features.

One aspect of the disclosure provides a handle and another aspect provides a method. Further features and details of the invention will become apparent from the claims, the description and the drawings. Thereby, features and details that are described in connection with the handle according to the invention, of course also apply in connection with the method according to the invention, and respectively vice versa, so that, with respect to the disclosure of individual aspects of the invention, alternate reference is always or can be made.

The object is achieved in particular by a handle for a motor vehicle, with a mounting carrier which can be fastened on the inside of a door of the motor vehicle, a grip lever, which can be arranged on the outside of the door of the motor vehicle and is fastened to the mounting carrier, an activation element, which is movably arranged on the mounting carrier. Here it is provided in particular that the mounting carrier has a control element, which is movable between a retaining position and a securing position, wherein, in the retaining position, the control element engages the activation element, whereby the activation element is held in a mounting position, in order to enable a simplified mounting of the grip lever, in which the securing position is detached from the activation element. It is advantageous that a simplified mounting of the handle is effected on the activation element. The activation element serves advantageously to trigger actions such as the opening and closing of a closing system of a motor vehicle. For example, a lock of the door can be opened and/or closed via activation or movement of the activation element. As the control element holds the activation element in the mounting position, a fastening of the grip handle on the activation element is simplified for the fitter. Subsequently, the fitter/operator can move the control element into its securing position, wherein the control element detaches from the activation element, which can move into its operating position.

Thus, a compact structural unit of the handle can be achieved, wherein the operator has a low mounting effort for fastening the handle to the motor vehicle door.

It can be provided that the control element has an actuator, wherein, upon actuation of the actuator, a movement of the control element is effected from the retaining position into the securing position and/or vice versa. It is conceivable that the actuator is located at least partially on the outside of the mounting carrier, in particular that the actuator can be operated manually. A movement of the control element takes place via an actuation of the actuator, whereby a decoupling of the control element from the activation element can be triggered.

It is further conceivable that the actuator is a screw element which acts on the mounting carrier and on the control element. A simple movement of the control element can be achieved via an actuation of the actuator, wherein the actuator is positioned freely accessible on the mounting carrier for the user in an advantageous manner, whereby ease of installation is increased.

It is possible that the mounting carrier is designed with a cavity in which the control element is inserted, wherein the cavity is designed so that the control element is movable within the cavity between the retaining position and the securing position. Advantageously, the geometric design of the cavity is at least partially adapted to the geometry of the control element. It is conceivable that the control element is inserted in the cavity, wherein the size of the cavity ensures that the control can be moved between the retaining position and the securing position.

Furthermore, it is conceivable within the context of the invention that the control element has a rib on at least one of its sides, whereby a reliable guide is effected during the movement of the control element on the mounting carrier. The at least one rib passes on the wall of the cavity, so that a well-functioning guide is ensured during the movement of the control element. Further, the rib effects that, during the movement of the control element, tilts and twists do not result within the cavity. The rib may extend in a direction corresponding to the direction of movement of the control element. Advantageously, at least one rib is formed on several sides of the control element. Advantageously, the control element forms a common, material-coordinated, monolithic component with the rib.

Furthermore, it is provided that the control element is arranged within the mounting carrier in such a manner that the control element is linearly movable between the retaining position and the securing position. The cavity is advantageously designed such that the control element is linearly movable between its two positions. A compact overall construction of the handle can be achieved hereby, wherein a further advantage also lies in the low-cost kinematics for moving the control element.

According to a further possibility, it may be provided that the control element has a retaining region which engages in the retaining position of the control element on a contact surface of the activation element. The retaining region may be, for example, a projection of the control element, which in turn rests on the contact surface of the activation element, whereby a movement of the activation element is blocked in the direction of operating position. Only when the securing element has left the retaining position, the activation element can leave the mounting position in the direction of the operating position.

It may be provided within the context of the invention that the control element is in operative connection with a securing element which can be arranged on the outside of the door, wherein, during the movement of the control element from the retaining position into the securing position, the distance between the securing element and the control element can be reduced. The securing element serves as protection, so that no environmental pollution, such as dirt, moisture, etc. can penetrate into the interior of the door in the direction of the mounting carrier. Furthermore, the securing element can be designed such that it has its effectiveness as anti-burglary protection. In addition, the securing element serves for effective fastening of the mounting carrier on the motor vehicle door. An increased force application on the mounting carrier to the door takes place via a reduction of the distance between the securing element and the control element.

It is further conceivable that the securing element has a latching means, which, in the securing position, extends into a counter-latching means of the control element. Thus the control element has a further function, namely to hold the securing element reliably in its position. The latching means can, e.g., extend with a projection in the direction of the control element. The counter-latching means is advantageously adapted according to the geometry of the latching means, so that in the securing position of the control element, both means can interact form-fitting to each other.

The latching means and the securing element as well as the counter-latching means and the control element respectively form a common, in particular material-coordinated or monolithic component.

Furthermore, it can be provided within the context of the invention that the grip lever has a dome which is held in a fastening zone of the activation element. The dome advantageously extends through an opening of the door into the interior, where the mounting carrier is fastened on the inside of the door. The dome is held on the fastening zone of the latching element, so that when the grip lever is pulled by the user, the dome is moved along to the outside, whereby a movement of the activation element is triggered. Advantageously, the activation element is rotatably mounted about an axle within the mounting carrier.

As a further advantage it can be provided that the securing element has a fastening region which acts on the mounting carrier. The fastening region can, e.g., be fastened installation-friendly to the mounting carrier in a positive- and/or force-fitting manner. In addition, it is advantageously provided that the mounting of the securing element takes place with the mounting carrier from the outside, that means, from the front side of the door.

It can for example be provided that, during a movement of the control element from the retaining position into the securing position, the securing element is pivotable about a rotation axis passing through the fastening region. In addition, it is conceivable within the scope of the invention that the fastening region is in contact with the dome. Via the pivoting of the securing element about the rotation axis passing through the fastening region, the latching means advantageously approaches the counter-latching means of the control element, whereby the securing element and the mounting carrier are pressed more strongly against the inside of the door. The fastening region of the securing element remains in contact with the dome of the grip lever, so that the dome is reliably secured in the fastening zone of the activating element.

It may be provided that the securing element has a seal on the side facing the control element. Advantageously, an effective protection against environmental influences, such as dirt, moisture, etc. can be effected hereby. The seal may, for example, be molded onto the securing element. Advantageously, the seal is made of a flexible material, wherein the securing element is metallic.

In a further possibility it can be provided that the latching means of the securing element has at least one active surface which, upon the movement of the control element into the securing position, engages a counter active surface of the control element, so that the latching means is pulled to the counter-latching means of the control element. It may be advantageous that the latching means exerts a travel path to the securing element during a pull towards the counter-latching means, which is advantageously less than 5 mm, particularly preferred less than 1.5 mm. While the control element moves linearly towards the securing position, the securing element pivots about its rotation axis, wherein the counter-active surface of the control element effectively acts on the active surface of the securing element to press the control element and the mounting carrier stronger on the inside of the door.

It is further conceivable that a closing cylinder unit is movably mounted on the mounting carrier, whereby the closing cylinder unit can be brought between a pre-mounting position and a final mounting position, wherein in particular the closing cylinder unit is rotatably mounted about an axle. In a possible embodiment of the invention, it may be conceivable that the handle has a closing cylinder unit in order, for example, to trigger a defined release action on the closing system of the motor vehicle via a key which can be inserted into the closing cylinder unit. In order to mount the grip lever on the mounting carrier, in particular on the activation element in an installation friendly manner, it is advantageous to hold the closing cylinder unit in a pre-mounting position. The operator is hereby offered more mounting space to fasten the grip lever on the mounting carrier, in particular on the activation element. Subsequently, the closing cylinder unit can be moved from its pre-mounting position into the final mounting position.

A further advantage within the context of the invention can be achieved if, in the retaining position of the control element, the closing cylinder unit is in the pre-mounting position and, in the securing position of the control element, the closing cylinder unit is in the final mounting position. Advantageously, it may be provided within the scope of the invention that the closing cylinder unit has a control geometry, which is engaged by the control element, in particular that the control element has a connecting element which is in operative connection with the control geometry. Advantageously, the control geometry as well as the connecting element acting in the control geometry favors well-functioning kinematics in order to bring the closing cylinder unit into its respective position. The connecting element may, e.g., be a projection, a cam or a reception, which is in operative connection with the control geometry. The control geometry can at least partially be curved or have a linear course. Hereby it can be ensured that two movements of two components can be realized, namely the movements of the closing cylinder unit and of the control element.

Furthermore, it is provided that the control element has a reception in which the closing cylinder unit is arranged, in particular that the closing cylinder unit is partially enclosed by the control element. On the one hand, a reliable protection of the closing cylinder unit is effected hereby. On the other hand, the control element of the closing cylinder unit offers a good possibility to move between the pre-mounting position and the end mounting position in a reliably mounted manner.

It is additionally advantageous if the control element has two securing sides and one actuation side, wherein the actuation side connects both opposing securing sides and the closing cylinder unit is arranged between both securing sides. On the actuation side, the actuator can be arranged, which is easily accessible to the operator, and preferably located on the outside of the mounting carrier. Advantageously, the securing sides are formed larger in their longitudinal extent than the actuation side, whereby a compact design of the handle can be achieved. The securing sides advantageously slide on the wall of the cavity. It can be provided that each or only one of the securing sides is designed with a rib according to the invention for reliable guidance during the movement of the control element on the mounting carrier.

It can be provided within the context of the invention that the control element has a reception region and the closing cylinder unit has an axle body through which the axle passes, wherein the axle body is arranged in the reception region, wherein in particular upon movement of the control element, the axle body moves relatively within the reception region. Advantageously, a reliable pivoting of the closing cylinder unit between the pre-mounting position and the final mounting position can take place hereby. The reception region of the control element is executed enlarged, so that the axle body can move linearly relatively within the reception region, wherein the axle body executes a rotation about the axle at the same time.

It is further conceivable that the reception region has an inner region and an edge region, wherein the reception region is designed as an opening, which becomes smaller from the inner region to the edge region, wherein, in the retaining position of the control element, the axle body is located in the inner region, and in the securing position of the control element, the axle body is located in the edge region. Advantageously, the reception region, with an inner region which is closed on one side and the edge region, which is advantageously designed in an open manner, offers enough movement space so that the axle body can move in the reception region in a rotating manner. The inner region can serve as a stop for the axle body. An advantage of the edge region, which is designed open on one side, is that the axle body can easily be inserted into the reception region without a great mounting effort.

As a further advantage it can be provided that the axle body is designed like a cylinder, wherein the lateral surface of the axle body at least partially has at least one level surface which contacts the wall of the reception region in the securing position of the control element. One advantage here is that a smooth rotation of the closing cylinder unit can take place through the cylinder-like axle body. The level surface arranged on the lateral surface effects advantageously that, in the securing position of the control the element, the closing cylinder unit is held in a latching manner in the final mounting position, in particular the axle body rests with its level surface rotationally blocked on the level wall of the reception region.

It may further be possible that the closing cylinder unit has at least one latching element which engages a counter latching element of the control element in the securing position of the control element, wherein, in the retaining position of the control element, the latching element is detached from the counter latching element, wherein in particular the latching element and/or the counter-latching element is/are formed rib-like. Advantageously, the control element has a further function, namely to hold the closing cylinder unit reliably in its final mounting position via its counter-latching element.

Additionally, it is conceivable within the context of the invention that the securing element has an opening for access to the closing cylinder unit, wherein in particular the control element is metallic. Advantageously, the control element is designed as a zinc die-cast part. Advantageously, the control element has a metal that is formed of the initials of the alloy components zinc and/or aluminum and/or magnesium and/or copper.

In a further possibility it can be provided that the securing element is formed in a closed manner, wherein in particular the control element is made of a plastic. Advantageously, the control element can be material-reinforced. In an advantageous exemplary embodiment, the control element forms a plastic injection molded part.

The object of the invention is also a method for mounting a handle for a motor vehicle, in particular a handle according to the invention, which has just been described, with a mounting carrier which can be fastened on the inside of a door of the motor vehicle and which has an activation element, which is arranged movably on the mounting carrier, a grip lever, which can be arranged on the outside of the door of the motor vehicle and is fastened to the mounting carrier. Here it is provided that the mounting carrier has a control element, which is movable between a retaining position and a securing position, in the retaining position, the control element engages the activation element, whereby the activation element is held in a mounting position, in order to enable a simplified mounting of the grip lever on the activation element, the control element detaches from the activation element via a movement of the control element and at the same time an increased force is exerted on the mounting carrier, so that the fastening effect of the mounting carrier to the inside of the door can be increased. The method according to the invention thereby brings about the same advantages as described in detail with reference to the handle according to the invention. In addition, the method may be suitable to provide a simplified mounting for the operator, in particular to achieve an installation-friendly fastening of the entire component group of the handle on the inside of the door.

According to a further advantage, it can be provided that a closing cylinder unit is in operative connection with the control element, wherein, upon movement of the control element into the securing position, the closing cylinder unit moves from a pre-mounting position to a final mounting position. The closing cylinder unit, which is in the pre-mounting position, enables a lower risk of collision with the grip lever to be fastened, which is inserted into the mounting carrier, after the grip lever has been fastened to the mounting carrier, the control element can be brought into the securing position.

Advantageously, it can be provided within the scope of the invention that the control element is in operative connection with a securing element which can be arranged on the outside of the door, wherein, during the movement of the control element from the retaining position into the securing position, the distance between the securing element and the control element is reduced, whereby an increased fastening force is exerted on the mounting carrier to the inside of the door. Advantageously, at least in regions, the distance between the control element and the securing element is reduced, by preferably less than 5 mm, particularly preferably less than 1.5 mm. A significant pressing action between the securing element and the motor vehicle door and the inside and the control element or the mounting carrier can be effected here.

Further advantages, features and details of the invention will become apparent from the following description in which exemplary embodiments of the invention are described in detail with reference to the drawings. Thereby, the features mentioned in the claims and in the description can be essential for the invention respectively individually or in an arbitrary combination.

### DRAWINGS

The figures show:

FIG. 1 illustrates a schematic view of a handle for a motor vehicle according to the invention,

FIG. 2 illustrates a view of a mounting carrier with a control element, which is in a securing position,

FIG. 3 illustrates a further view of the mounting carrier, wherein the control element is in a retaining position, which differs from the securing position,

FIG. 4 illustrates a further view of the control element according to FIG. 3.

FIG. 5 illustrates a further perspective view of the control element according to FIG. 3.

FIG. 6 illustrates a further view of the control element according to FIG. 3.

FIG. 7 illustrates a further view of the control element, wherein the control element is in its securing position,

FIG. 8 illustrates a further view of the control element, at which a securing element is arranged, wherein the control element is in the retaining position,

FIG. 9 illustrates a further view of the control element, which takes up the securing position,

FIG. 10 illustrates a further view of the control element, at which the securing element is arranged, wherein the control element is in the retaining position,

FIG. 11 illustrates the control element in its securing position,

FIG. 12 illustrates the control element, which is engaged in the closing cylinder unit.

In the following figures, the same reference numerals are used for the same technical features also of different exemplary embodiments.

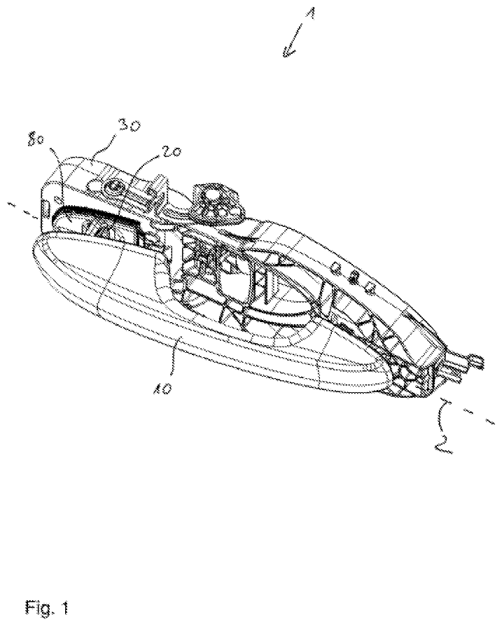

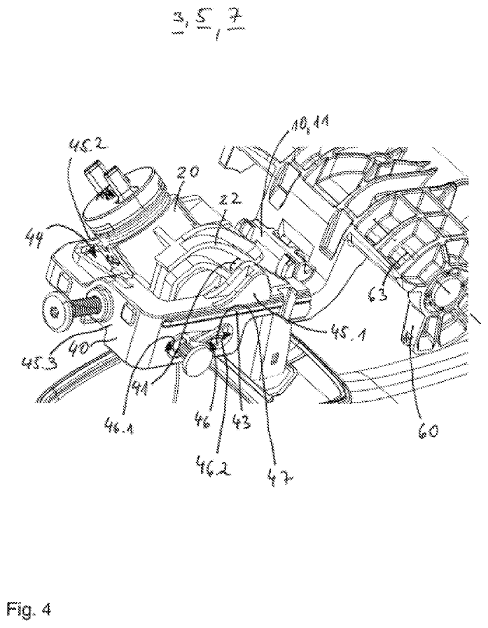

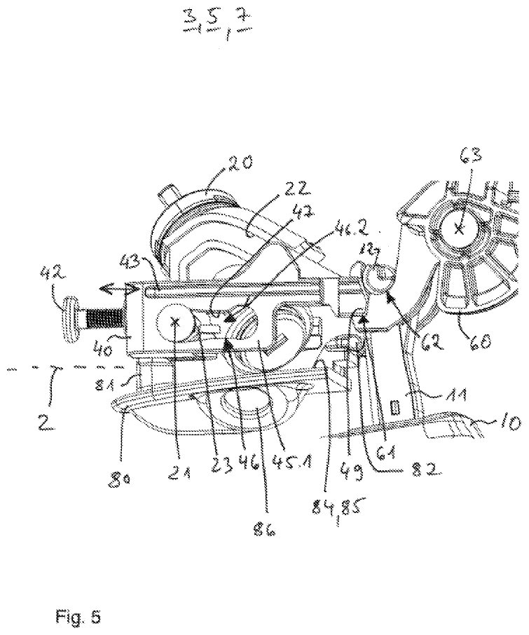

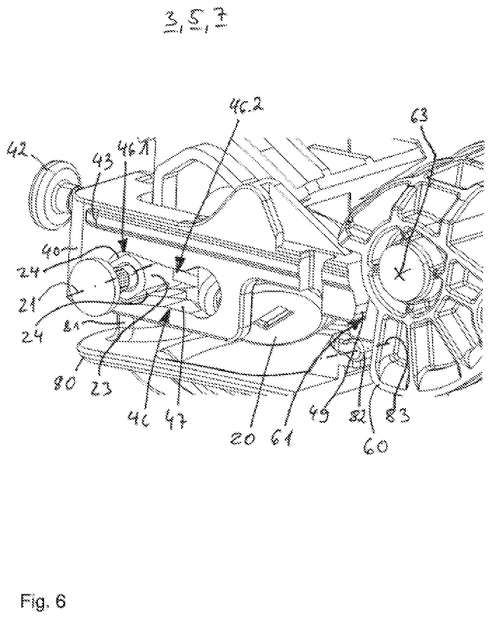

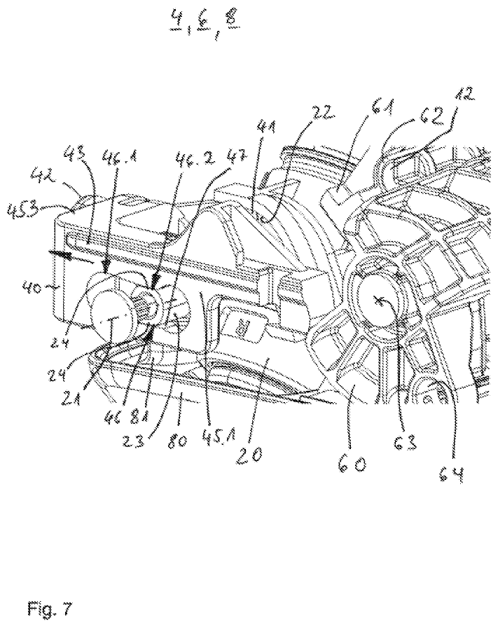

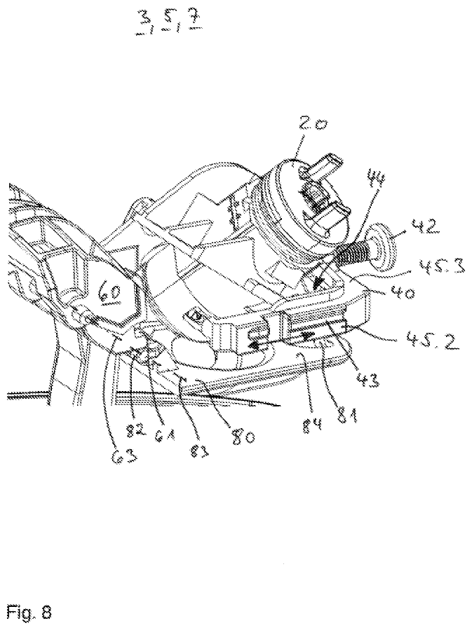

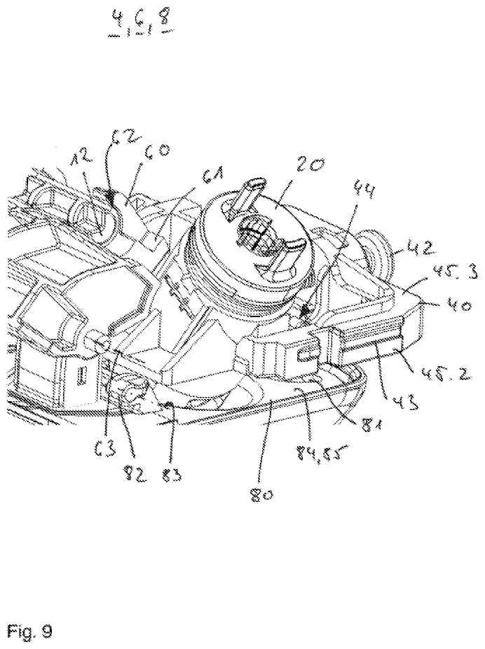

FIGS. 1 to 12 shows an exemplary embodiment of a handle 1 according to the invention, which can be fastened to a door 2 of a motor vehicle. The handle 1 has a mounting carrier 30, which is fastened on the inside of the door 2. On the outside of the door 2, the handle 1 has a grip lever 10, which is to be actuated by the operator, in particular can be pulled, wherein according to FIG. 1 the grip lever 10 is a pulling grip lever. The grip lever 10 is rotatably mounted on the mounting carrier on its right side, which is not shown explicitly. On its left side, the grip lever 10 has a dome 11, which is shown for example in FIG. 5, so that by a pulling action of the user, the dome 11 initiates an action of a defined kinematics within the mounting carrier 30. According to the exemplary embodiment, the grip lever 10 is in operative connection with an activation element 60, which means that a release for a closing system within the motor vehicle can be triggered by a movement of the activation element 60. For example, it is conceivable that an opening process and/or closing process of a door 2, etc. can be effected via a movement of the activation element 60. In the present exemplary embodiment, the activation element 60 is rotatably mounted on the mounting carrier 30 about an axis 63. The activation element 60 has a fastening zone 62, in which a free end 12 of the mandrel 11 is held reliably. The activation element 60 additionally has a fastening reception 64, which is shown for example in FIG. 7, in which, for example, a Bowden cable can be fastened. By means of a corresponding movement of the activation element 60, the Bowden cable can be pulled, whereby a mechanical release action is started.

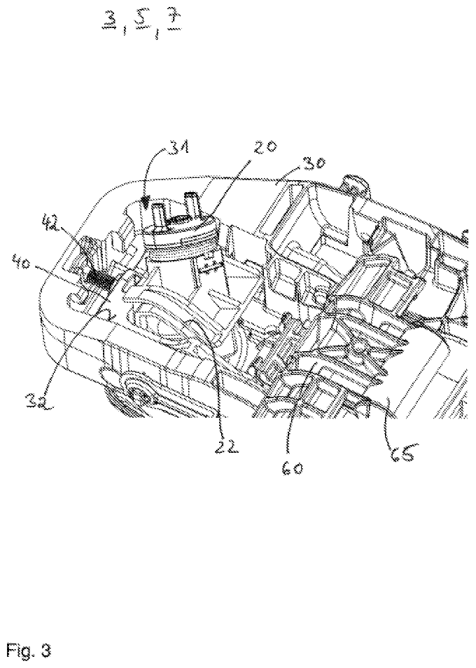

In addition, it is conceivable that the activation element 60 has a mass balance 65, which is shown in FIG. 3. The mass balance 65 serves to prevent the door handle 10 from moving out of the door 2 via the acceleration forces in the event of a crash.

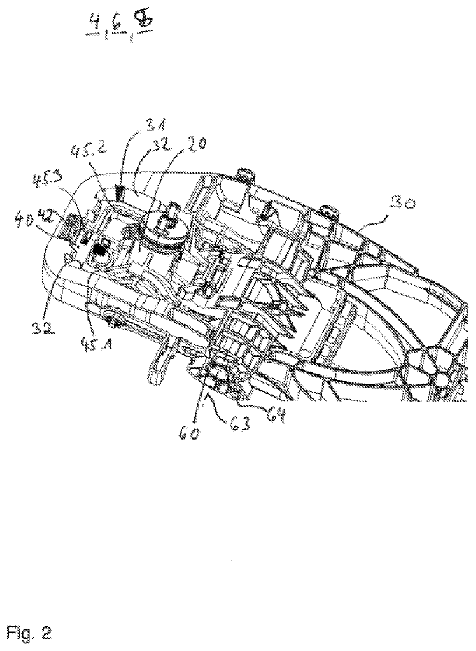

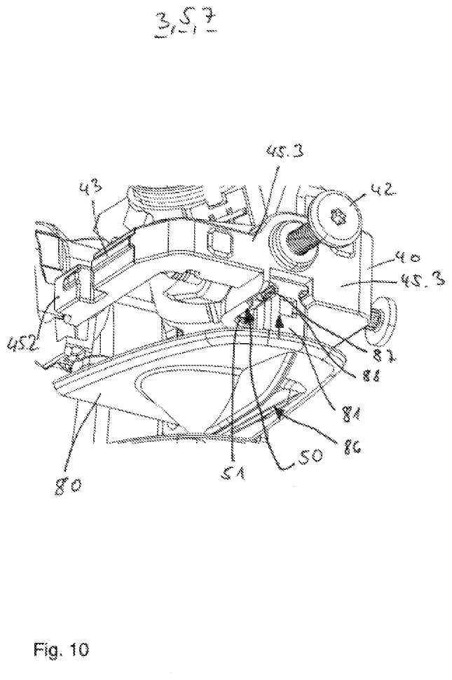

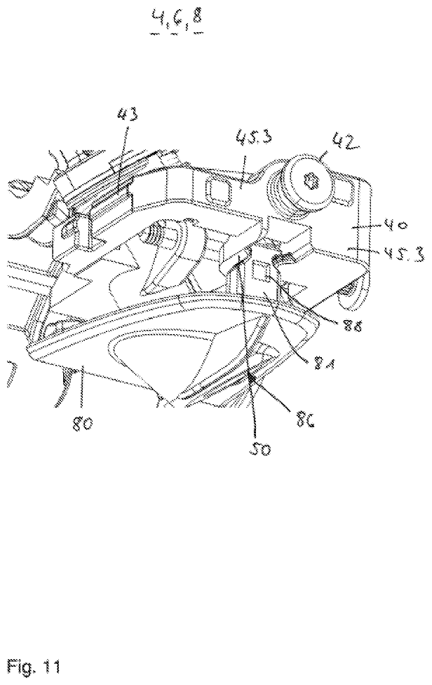

According to the exemplary embodiment according to FIG. 1 to FIG. 12, it is shown that the handle 1 has a control element 40, which is in operatively connected to a securing element 80 arranged on the outside of the door 2. The control element 40 can be moved from a retaining position 5, which is shown in FIGS. 3 to 6, FIGS. 8 and 10 into a securing position 6, which is shown in FIGS. 2, 7, 9 and 11. The control element 40 has different functions hereby, which are described below. By means of a movement of the control element 40 from the retaining position 5 to the securing position 6, the distance between the securing element 80 and the control element 40 is reduced, which is particularly illustrated in FIGS. 10 and 11. Here, the securing element 80 has a locking means 81, which engages a counter locking means 50 of the control element 40.

According to the other figures, it can be seen that the securing element 80 has, on the side opposite the locking means 81, a fastening region 82 which is arranged on the mounting carrier 30. During the movement of the control element 40 from the retaining position 5 into the securing position 6, the securing element 80 pivots about a rotation axis 83, wherein the rotation axis 83 passes through the fastening region 82. Starting with FIG. 5, a linear movement of the control element 40 to the left (see double arrow) takes place, wherein, at the same time, the securing element 80 is pivoted clockwise about the rotation axis 83, which passes through the fastening region 82. Hereby, the securing element 80 with its locking means 81 carries out a certain lifting movement in the direction of the control element 40, which is less than 2 mm. Advantageously, the securing element 80 has a seal 85 on the side 84 facing the control element 40, which is not explicitly shown.

In order for the securing element 80 to be moved in the direction of the door 2 via a movement of the control element 40 in the direction of the securing position 6, the locking means 81 of the securing element 80 has active surfaces 87 which engage counter active surfaces 51 of the control element 40 during the movement of the control element 40 into the securing position 6. The active surfaces 87 and the counter active surfaces 51 are aligned with each other in such a manner that the locking means 81 is pulled to the counter locking means 50 when the control element 40 is moved in the direction of the securing position 6. The arrow in FIG. 10, which is directed upward, shows the lifting movement of the securing element 80 which is rotatably mounted on the opposite side of the rotation axis 83.

The control element 40 has an actuator 42, wherein upon actuation of the actuator 42, the movement of the control element 40 from the retaining position 5 into the securing position can be triggered and/or vice versa. Hereby, the actuator 42 is arranged on the outside of the mounting carrier 30, so that the actuator 42 can be easily operated by the operator. Hereby, the actuator 42, which is a screw member, can be operated manually. The actuator 42 acts both on the mounting carrier 30 and on the control element 40.

The mounting carrier 30 has a cavity 31, in which the control element 40 is inserted in a movable manner. The control element 40 further, on its securing sides 45.1, 45.2, has respectively a rib 43, which serves as a guide during the movement of the control element 40 on the mounting carrier 30. The securing side 45.1 is opposite the securing side 45.2. While the control element 40 is being moved, the ribs 43 slide on the wall 32 of the cavity 31.

In the retaining position 5 of the control element 40, the control element 40 engages the activation element 60, whereby the activation element 60 is obtained in a mounting position 7. A simplified mounting of the grip lever 10 on the activation element 60 is effected hereby.

The control element 40 has a retaining region 49, which engages a contact surface 61 of the activation element 60 in the retaining position 5 of the control element 40.

FIG. 5 further shows that the dome 11 of the grip lever 10 is in contact with the fastening region 82 of the securing element 80. In addition, the exemplary embodiment shows that the handle 1 can be designed with a closing cylinder unit 20. It should be noted, however, that all embodiments of the exemplary embodiment can also refer to a handle 1 that does not require a closing cylinder unit 20. In the present exemplary embodiment, the handle 1 as mentioned shows a closing cylinder unit 20 which is movably mounted on the mounting carrier 30. Here, the closing cylinder unit 20 can be brought between a pre-mounting position 3 and a final mounting position 4, wherein the closing cylinder unit 20 is mounted rotatably about an axle 21. In the retaining position 5 of the control element 40, the closing cylinder unit 20 is in its pre-mounting position 3. In the securing position 6 of the control element 40, however, the closing cylinder unit 20 is in its final mounting position 4. In the final mounting position 4, the closing cylinder unit 20 is accessible via a key from the user. If the grip lever 10 is not actuated on the door 2, the grip lever 10 completely covers the head region of the closing cylinder unit 20.

The closing cylinder unit 20 has a control geometry 22, which the control element 40 engages. Hereby, the control element 40 on a connecting element 41, which is formed like a projection and which is in operative connection with the control geometry 22. Hereby, the control geometry 22 is designed at least partially in a curved manner, whereby a rotational movement is about the axis 21 is favored.

The control element 40 has a reception 44, in which the closing cylinder unit 20 is arranged. The closing cylinder unit 20 is thus partially enclosed by the control element 40. In the present exemplary embodiment, the control element 40 has two securing sides 45.1, 45.2 and an actuation side 45.3. The actuation side 45.3 connects both opposing securing sides 45.1, 45.2. The closing cylinder unit 20 is hereby located between the securing sides 45.1, 45.2. The actuator 42 is located in the actuation side.

The control element 40 has a reception region 46 and the closing cylinder unit 20 has an axle body 23, wherein the axle 21 passes through the axle body 23. The axle body 23 is arranged in the reception region 46, wherein, during the movement of the control element 40, the axle body 23 moves within the reception region 46.

According to FIGS. 5, 6, 7, the reception region 46 has an inner region 46.1 and an edge region 46.2. The reception region 46 is designed as an opening, so that the axle body 23 can be mounted easily. In the retaining position 5 of the control element 50, the axle body 23 is located in the inner left region 46.1 of the reception region 46. In the securing position 6 of the control element 40, the axle body 23 is located at the edge region 46.2, which is shown in FIG. 7. The axle body 23 is designed like a cylinder, wherein the axle body 23 has two level surfaces 24 on its lateral surface. In the securing position 6 of the control element 40, the level surfaces 24 abut against level walls 47 of the reception region 46, whereby a locking action of the closing cylinder unit 20 on the control element 40 is effected.

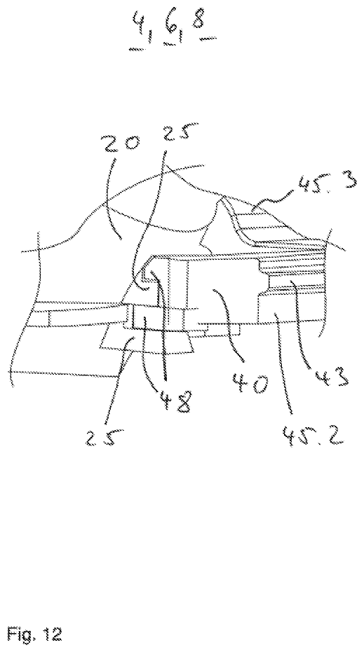

The closing cylinder unit 20 can also have a latching element 25, which, in the securing position 6 of the control element 40, engages a counter latching element 48 of the control element 40, which is shown schematically in FIG. 12. In the retaining position 5 of the control element 40, however, the latching element 25 is released from the counter-latching element 48, which is not explicitly shown. In the following exemplary embodiment, the latching element 25 and the counter-latching element 48 is formed like a rib.

The securing element 80 has an opening 86 for access to the closing cylinder unit 20. The control element 40 is preferably made metallic for safety reasons. The securing element 80a may be made of a steel material. In a further alternative not explicitly shown, it is conceivable that the securing element 80 is designed to be closed. In this embodiment, the handle 1 is formed without the closing cylinder unit 20. Here, the control 40 may be made of a plastic.

The handle 1 according to the invention is characterized in particular by the fact that the mounting method for fastening the handle 1 to a motor vehicle is substantially simplified. First, the mounting carrier 30 is fastened to the control element 40 on the inside of the door 2. Here it is conceivable that a closing cylinder unit 20 is integrated or the mounting support 30 does not require a closing cylinder unit 20. Subsequently, the securing element 80 is fixed from the outside of the door 2, wherein, also from the outside, the grip lever 10 with its dome 11 is also guided to the door 2 or fastened there. Here, the dome 11 is guided in the direction of the mounting carrier 30, wherein the activation element 60 is in the mounting position 7. In the mounting position 7, it is effected that the control element 40 holds the activation element 60 in the mounting position 7. If the dome 11 is arranged on the activation element 60, the operator can act on the actuator 42 or rotate, so that a movement of the control element 40 in the direction of securing position 4 is initiated. The activation element 60 loses contact with the control element 40, so that the activation element 60 automatically leaves the mounting position 7 in the direction of the operating position 8. Via the movement of the control element 40 in the direction of the securing position 6, a force input into the securing element 80 takes place, which is pulled about its rotation axis 83 in the direction of the control element 40. At the same time a force is exerted on the mounting carrier 30, which presses on the inside of the door 2 as a result thereof. An effective tension of the handle 1 with the door 2 can be achieved hereby.

If the handle 1 comprises a closing cylinder unit 20, the closing cylinder unit 20 can be moved from a pre-mounting position 3 into a final mounting position 4 by the movement of the control element 40 into the securing position 6. If the final mounting position 4 is reached, the latching elements 25 act with the counter-latching elements 48 of the control element 40, so that a locking position of the closing cylinder unit 20 is reached.

The above explanation of the embodiments describes the present invention exclusively in the context of examples. Of course, individual features of the embodiments, if technically feasible, can be combined freely with one another without departing from the scope of the present invention.

### LIST OF REFERENCE NUMERALS

1 Handle
2 Door
3 Pre-mounting position
4 Final mounting position
5 Retaining position
6 Securing position
7 Mounting position
8 Operating position
10 Grip lever
11 Dome
12 Free end
20 Closing cylinder unit
21 Axle
22 Control geometry
23 Axle body
24 Level surface
25 Latching elements
30 Mounting carrier
31 Cavity
32 Wall
40 Control element
41 Connecting element, projection
42 Actuator
43 Ribs
44 Reception
45.1 Securing side
45.2 Securing side
45.3 Actuation side
46 Reception region
46.1 Inner region
46.2 Edge region
47 Wall
48 Counter latching element
49 Retaining region
50 Counter locking means
51 Counter active surface
60 Activation element
61 Contact surface
62 Fastening zone
63 Axle
64 Fastening reception
65 Mass balance
80 Securing element
81 Locking means
82 Fastening region
83 Rotation axis
84 Side
85 Seal
86 Opening
87 Active surface
88 Reception

1. A handle for a motor vehicle, with a mounting carrier, which can be fastened on the inside of a door of the motor vehicle, a grip lever, which can be arranged on the outside of the door of the motor vehicle and which is fastened to the mounting carrier, an activation element which is arranged movably on the mounting carrier, wherein the mounting carrier has a control element which is movable between a retaining position and a securing position, wherein, in the retaining position, the control element engages the activation element, whereby the activation element is held in a mounting position, in order to facilitate a simplified mounting of the handle, in the securing position, the control element is detached from the activation element.

2. The handle according to claim 1, wherein the control element has an actuator, wherein, upon actuation of the actuator, a movement of the control element is effected from the retaining position into the securing position and/or vice versa.

3. The handle according to claim 2, wherein the actuator is located at least partially on the outside of the mounting carrier, in particular that the actuator can be operated manually.

4. The handle according to claim 2, wherein the actuator is a screw element which acts on the mounting carrier and on the control element.

5. The handle according to claim 1, wherein the mounting carrier is designed with a cavity in which the control element is inserted, wherein the cavity is designed so that the control element is movable within the cavity between the retaining position and the securing position.

6. The handle according to claim 1, wherein the control element has a rib on at least one of its sides, whereby a reliable guidance is effected during the movement of the control element on the mounting carrier.

7. The handle according to claim 1, wherein the control element is arranged within the mounting carrier in such a way that the control element can be moved linearly between the retaining position and the securing position.

8. The handle according to claim 1, wherein the control element has a retaining region which, in the retaining position of the control element, engages a contact surface of the activation element.

9. The handle according to claim 1, wherein the control element is in operative connection with a securing element which can be arranged on the outside of the door, wherein, during the movement of the control element from the retaining position into the securing position, the distance between the securing element and the control element can be reduced.

10. The handle according to claim 9, wherein the securing element has a locking means, which extends into a counter locking means of the control element in the securing position.

11. The handle according to claim 9, wherein the handle has a dome which is held in a fastening zone of the activation element.

12. The handle according to claim 11, wherein the securing element has a fastening region which acts on the mounting carrier.

13. The handle according to claim 12, wherein during a movement of the control element from the retaining position into the securing position, the securing element is pivotable about a rotation axis passing through the fastening region.

14. The handle according to claim 12, wherein the fastening region is in contact with the dome.

15. The handle according to claim 9, wherein the securing element has a seal on a side facing the control element.

16. The handle according to claim 10, wherein the locking means of the securing element has at least one active surface which, during the movement of the control element into the securing position, acts on a counter active surface of the control element, so that the locking means is pulled toward the counter locking means of the control element.

17. The handle according to claim 9, wherein a closing cylinder unit is movably mounted on the mounting carrier, whereby the closing cylinder unit can be brought between a pre-mounting position and a final mounting position, wherein in particular the closing cylinder unit is mounted rotatably about an axis.

18. The handle according to claim 17, wherein in the retaining position of the control element the closing cylinder unit is in the pre-mounting position and in the securing position of the control element, the closing cylinder unit is in the final mounting position.

19. The handle according to claim 17, wherein the closing cylinder unit has a control geometry on which the control element acts, in particular that the control element has a connecting element, which is in operative connection with the control geometry.

20. The handle according to claim 17, wherein the control element has a reception in which the closing cylinder unit is arranged, in particular that the closing cylinder unit is partially enclosed by the control element.

21. The handle according to claim 17, wherein the control element has two securing sides and one actuating side, wherein the actuating side connects both opposing securing sides and the closing cylinder unit is arranged between both securing sides.

22. The handle according to claim 17, wherein the control element has a reception region and the closing cylinder unit has an axle body through which the axle axis extends, wherein the axle body is arranged in the reception region, wherein in particular upon movement of the control element, the axle body moves relative within the reception region.

23. The handle according to claim 22, wherein the reception region has an inner region and an edge region, wherein the reception region is designed as an opening, which becomes smaller from the inner region to the edge region, wherein, in the retaining position of the control element, the axle body is located in the inner region and, in the securing position of the control element, the axle body is located in the edge region.

24. The handle according to claim 22, wherein a lateral surface of the axle body has at least one flat surface, which in the securing position of the control element has a wall of the reception region contacted.

25. The handle according to claim 17, wherein the closing cylinder unit has at least one latching element which, in the securing position of the control element, engages a counter latching element of the control element, wherein, in the retaining position of the control element, the at least one latching element is detached from the counter latching element, wherein in particular the at least one latching element and/or the counter latching element is/are formed like a rib.

26. The handle according to claim 17, wherein the securing element has an opening for access to the closing cylinder unit, wherein in particular the control element is metallic.

27. The handle according to claim 9, wherein the securing element is designed to be closed, wherein in particular the control element is made of a plastic.

28. A method for mounting a handle according to claim 1, with a mounting carrier, which can be fastened on the inside of a door of the motor vehicle, and which has an activation element, which is movably arranged on the mounting carrier, a grip lever which can be arranged on the outside of the door of the motor vehicle and which is fastened to the mounting carrier, wherein the mounting carrier has a control element which is movable between a retaining position and a securing position, in the retaining position, the control element engages the activation element, whereby the activation element is held in a mounting position, in order to enable a simplified mounting of the grip lever on the activation element, via a movement of the control element into the securing position, the control element is detached from the activation element and at the same time an increased force is exerted on the mounting carrier, so that the fastening action of the mounting carrier to the inside of the door can be increased.

29. The method according to claim 28, wherein a closing cylinder unit is in operative connection with the control element, wherein, upon movement of the control element into the securing position, the closing cylinder unit moves from a pre-mounting position to a final mounting position.

30. The method according to claim 28, wherein the control element is in operative connection with a securing element which can be arranged on the outside of the door, wherein, during the movement of the control element from the retaining position into the securing position, the distance between the securing element and the control element is reduced, whereby an increased fastening force is exerted on the mounting carrier to the inside of the door.
